(19) United States
(12) Patent Application Publication
(10) Pub. No.: US 2012/0272233 A1
(43) Pub. Date: Oct. 25, 2012

(54) AUTOMATIC CREATING METHOD OF GROUP APPLICATION AND COUPLE APPLICATION

(76) Inventor: Won Jae LEE, Seoul (KR)

(21) Appl. No.: 13/542,534

(22) Filed: Jul. 5, 2012

(30) Foreign Application Priority Data
Dec. 20, 2010 (KR) 10-2010-0130821
Dec. 20, 2010 (KR) 10-2010-0130856

(51) Int. Cl. G06F 9/445; G06F 15/16

(52) U.S. Cl. 717/178

(57) ABSTRACT

Disclosed are an automatic creating method of a group application or a couple application which comprises (1) downloading and installing a group application or a couple application creating application by an administrator; (2) creating the group application or the couple application from the application creating application by the administrator; (3) inputting an identification means of a client or a counterparty relating to the group application or the couple application by the administrator; and (4) transmitting the group application or the couple application to the client or the counterparty. Thus, an Internet space in which only a small number of people or two person may communicate with each other and share information may be created simply and easily.

### BACKGROUND

1. Field

Apparatuses and methods consistent with the exemplary embodiments relate to an automatic creating method of a group application, and more particularly, to an automatic creating method of a group application which automatically creates an exclusive Internet space for communication between a small number of members easily and conveniently and an automatic creating method of a couple application, and more particularly, to an automatic creating method of a couple application which is a communication space automatically created exclusively for two persons.

2. Description of the Related Art

Advanced Internet allows people to search any and all information of the world in real-time, and among others, Google Earth and other similar programs provide the real looks of the world at home.

Moreover, social network service (SNS) such as Facebook or Twitter enables people to make friends with others around the world without difficulty and chat and share information with them.

The term “global village” is not new anymore and even gives out-dated impression. On the web, anyone can listen to what world-famous leaders and CEO say in real-time and make friends with them.

However, as Andre Malraux said in his book “La Condition Humaine” that the condition of human is solitude, no one can deny that such saying is still effective even at this time when the human's imagination has come true most technically.

People meet new people every day and talk and share information with them through the SNS, but they are far away from each other physically. Further, it would be difficult to share personal, confidential information and talk about what made them happy or sad today.

In such circumstances, an Internet space in which people can become more acquainted, make relationships with others, and can be satisfied with that there is someone who is close to them would be needed.

That is, an Internet space which is allowed for limited people, enables members or families or clubs who gather for certain purposes to share secrets without limitation would be needed. Further, such Internet space has a very humane function that enables people to overcome a sense of alienation in a rapidly developing world.

Nowadays, human relationships are easily built and destructed. That is, human relationships are very weak. Divorce rate is sharply rising. In that sense, an Internet space which makes couple's love secure and helps couples keep faithful to each other would be needed.

It is expected that such Internet space reduces foul functions of the society and helps to secure public morals. Even if the world becomes closer and technology advances, humans live their social life based on home. To protect such fundamental group of the society and secure couple's love which is the basis for human relationships, an Internet space is needed.

Also, such Internet space may allow people to strengthen trust in the society where betrayal surges.

### SUMMARY

Accordingly, one or more exemplary embodiments provide an automatic creating method of a group application which easily and simply creates an Internet space for communication and sharing of information among a small number of people.

Another exemplary embodiment is to provide an automatic creating method of a group application which provides an Internet communication space for a small number of people who are isolated from the public in the Internet.

Still another exemplary embodiment is to provide an automatic creating method of a group application which is exclusive for members.

Still another exemplary embodiment is to provide an automatic creating method of a group application which enables members to build mutual trust.

The foregoing and/or other aspects may be achieved by providing an automatic creating method of a group application, the method comprising: (1) downloading and installing a group application creating application by an administrator; (2) creating the group application from the application creating application by the administrator; (3) inputting an identification means of a client relating to the group application by the administrator; and (4) transmitting the group application to the client.

The method further comprises (5) creating the group application automatically in a receiver of the client if the identification means at the operation (3) is consistent with the receiver of the client receiving the group application.

The identification means at operation (3) comprises one of an ID number of a mobile device, resident registration number, email address and mobile telephone number.

The group application which is created at operation (2) is registered with a server which manages the application creating application.

The method further comprises sharing photos, video and documents registered by either the administrator or the client in the group application.

The client of the group application comprises study group members, club members and small gathering members comprising up to 50 members in total.

The method further comprises maintaining a space exclusively for the administrator and the client of the group application and not disclosed to a third party.

Accordingly, one or more exemplary embodiments provide an automatic creating method of a couple application which provides a simple space for couples only in the Internet without difficulty.

Another exemplary embodiment is to provide an automatic creating method of a couple application which stores couple's information and materials therein, strengthens trust between the couple, and provides a space for the couple to grow love.

Still another exemplary embodiment is to provide an automatic creating method of a couple application which is exclusive for a couple as members.

The foregoing and/or other aspects may be achieved by providing an automatic creating method of a couple application which comprises (1) downloading and installing a couple application creating application by an administrator; (2) creating a couple application from the couple application creating application by the administrator; (3) inputting an identification means of a counterparty in the couple application by the administrator; and (4) transmitting the couple application to the counterparty.

The method further comprises (5) creating the couple application automatically in a receiver of the counterparty if the identification means at the operation (3) is consistent with the receiver of the counterparty receiving the couple application and the counterparty permits such creation.

The identification means at operation (3) comprises one of an ID number of a mobile device, resident registration number, email address and mobile telephone number.

The couple application which is created at operation (2) is registered with a server which manages the couple application creating application.

The method further comprises sharing photos, video and documents registered by either the administrator or the counterparty in the couple application.

The couple application is not subscribed for by a third party except the administrator and the counterparty.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 illustrates a concept of an exemplary first embodiment of the present invention;

FIG. 2 illustrates an example of a group application which is created in FIG. 1;

FIG. 3 is a block diagram according to the exemplary first embodiment of the present invention; and

FIG. 4 illustrates a creating method of the group application according to the present invention.

FIG. 5 illustrates a concept of an exemplary second embodiment of the present invention;

FIG. 6 illustrates an example of a couple application which is created in FIG. 5;

FIG. 7 is a block diagram according to the exemplary second embodiment of the present invention; and

FIG. 8 illustrates a creating method of the couple application according to the present invention.

### DETAILED DESCRIPTION OF EXEMPLARY EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

### First Embodiments

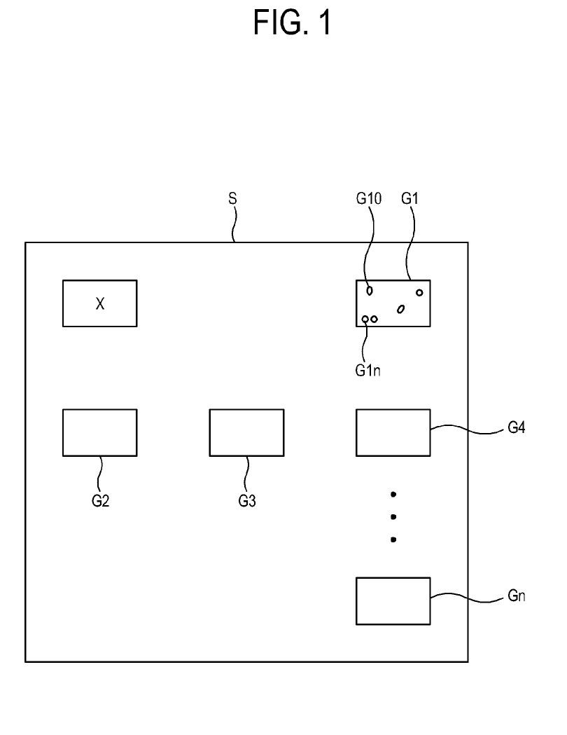

Hereinafter, an automatic creating method of a group application according to the present invention will be described in detail with reference to FIGS. 1 to 4.

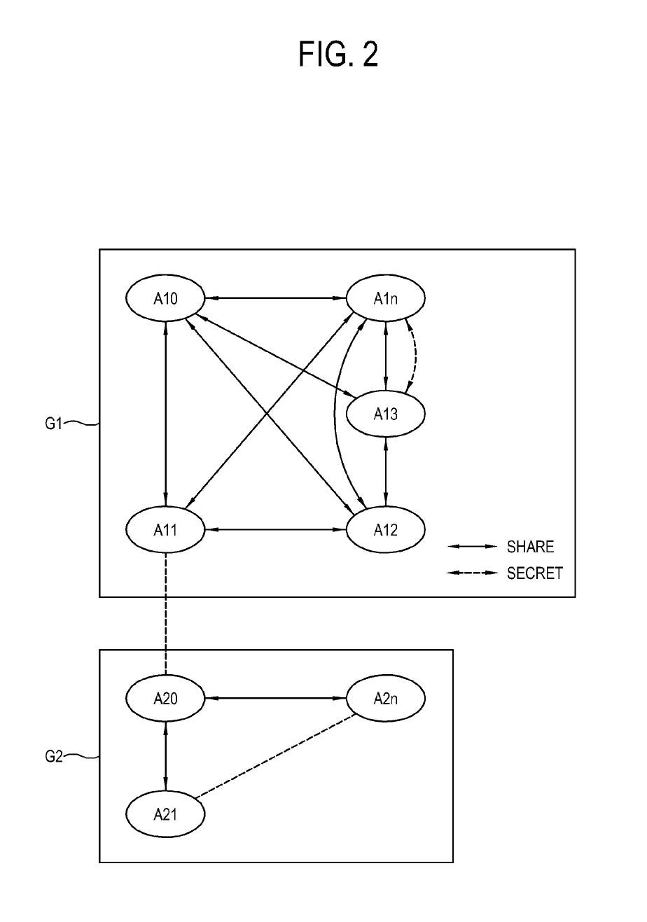

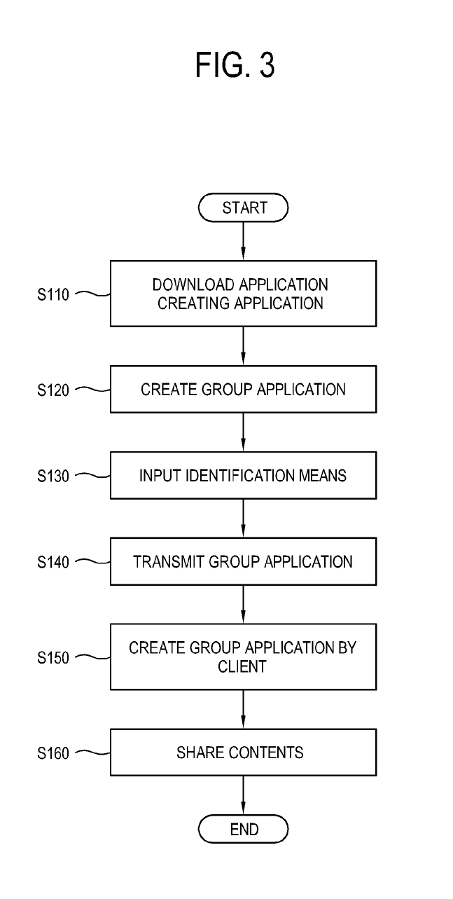

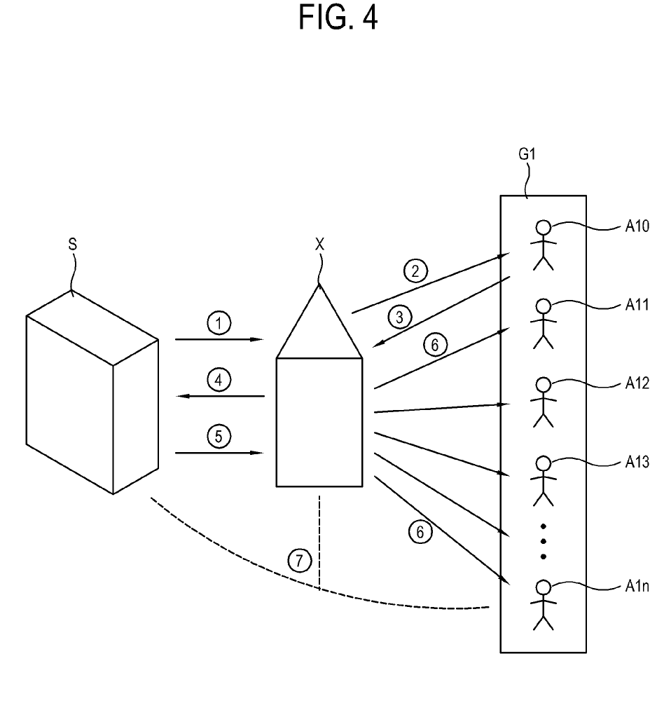

FIG. 1 illustrates a concept of an exemplary first embodiment of the present invention. FIG. 2 illustrates an example of a group application which is created in FIG. 1. FIG. 3 is a block diagram according to the exemplary first embodiment of the present invention. FIG. 4 illustrates a creating method of the group application according to the present invention.

As shown therein, an automatic creating method of a group application according to the present invention includes an application creating application X and a plurality of group applications G created by the application creating application X in a server S.

The application creating application X may be present in Android's or Apple's application store (hereinafter, the “friend app” for purposes of convenience) on the web, and an administrator A10 searches the friend app, downloads and installs the application creating application X in his/her electronic device including a mobile phone, etc. (S110).

The administrator A10 creates the group application G in his/her electronic device (S120). The administrator A10 may easily create the group application G without using an additional tool. For example, the administrator A10 may click ‘create new group application’ from the friend app and create the group application G.

The administrator A10 designates clients A1, A12, A13, . . . and A1n with whom he/she shares contents from the created group application G, and inputs an identification means of the clients A1, A12, A13, . . . and A1n in the created group application G (S130). The identification means may include one of an ID number of the mobile device, and resident registration number, email address and mobile telephone number of the clients A11, A12, A13, . . . and A1n. The identification means may include at least two of the foregoing.

Then, the administrator A10 transmits the created group application G to the designated clients A11, A12, A13, . . . and A1n (S140). Such transmission may be conducted via email or the number of the mobile device including a smart phone.

The transmitted group application G is automatically created if the clients A11, A12, A13, . . . and A1n are consistent with the identification means input by the administrator A10 (S150). During such process, the clients A11, A12, A13, . . . and A1n may include an operation of accepting and confirming subscription for the group application G transmitted by the administrator A10.

Then, the administrator A10 and the clients A11, A12, A13, . . . and A1n may share the created group application G (S160). That is, the created group application G is an exclusive space for only the administrator A10 and the clients A11, A12, A13, . . . and A1n. In the group application G, the administrator A10 and the clients A11, A12, A13, . . . and A1n may freely register messages, photos, and video, which may be shared therebetween. The group application G is an exclusive space for members, and an SNS function may be performed only with respect to the administrator A10 and the clients A11, A12, A13, . . . and A1n as the members of such group application G.

Terms of new subscription for the group application G is very strict. For example, a new member is not permitted to become a member unless a majority of the clients A11, A12, A13, . . . and A1n consents to such new subscription. Neither the administrator A10 nor the clients A11, A12, A13, . . . and A1n may transmit the created group application G to a third party, and anyone which is not identified as a member cannot input an identification means.

Such group application G may be a very useful Internet communication space for a small gathering, club, study group members, etc. which has up to 50 members. Unlike a typical Internet café, the group application G may not be disclosed to others in the Internet and may provide a space only for people isolated in the Internet.

Within the group application G, a message may be transmitted to limited persons. For example, a message may be shared only between the clients A13 and A1n as in FIG. 2.

The group applications G which are created by the application creating application X are automatically created and designated with ID numbers and names and may be registered with and managed by the server S. For example, management of the server S may include cloud computing. That is, management of the server S may include a computing environment in which IT service such as data storage, network, content usage may be used at a time through the server S in the Internet.

The administrator A10 may create several group applications G1, G2, G3, etc. Also, the clients A11, A12, A13, . . . and A1n may become an administrator A10 who creates another group applications G2, G3, etc.

That is, as shown in FIG. 2, the client A11 of the group application G1 may become an administrator A20 of the group application G2. However, even in this case, communication and sharing information in the group application G1 is not disclosed to clients A21, A22, . . . and A2n of the another group application G2.

Hereinafter, a creating method of the group application according to the present invention will be described with reference to FIG. 4. For purposes of convenience, G1 will be explained as an example of the group application G.

A person who manages a program called the application creating application X stored and managed in the server S registers the program with the app store for mobile device users to download it (operation \textcircled{1}).

The administrator A10 who desires to create the initial group application G1 downloads the application creating application X from the app store and creates the group application G1 (operation \textcircled{2}).

The administrator A10 inputs the identification means and information of the clients A11, A12, A13, . . . and A1n (operation \textcircled{3}). Such identification means and information is stored and managed in the server S through the app store (operation \textcircled{4}).

The server S allows the group application G1 to be created in the app store (operation \textcircled{5}).

The administrator A10 transmits the group application G1 to the clients A11, A12, A13, . . . and A1n, and if the identification means input by the administrator A10 is consistent with the mobile device of the clients A11, A12, A13, . . . and A1n, the group application G1 is automatically created from the mobile device of the clients A11, A12, A13, . . . and A1n. During such process, the clients A11, A12, A13, . . . and A1n may confirm the identification means, and accept and confirm the subscription for the group application G1.

Then, the exclusive group application G1 in which only the members may communicate and share information and materials and which is not disclosed to a third party is created.

The overall process is managed by the server S, which may manage, store all information and materials and provide users with such contents and materials (operation \textcircled{7}).

According to the present invention, an Internet space in which a small number of people isolated from the Internet may gather and meet may be provided. An exclusive application only for a small number of people may be created simply and conveniently. Also, such application may be maintained as an exclusive space for members in the Internet or mobile devices.

According to the present invention, an application may be provided for a small number of people isolated from the Internet.

Also, an application in which only a small number of people may communicate with each other in the Internet may be created simply and easily.

Further, such application is exclusive for members and not disclosed to third parties in the Internet or in a mobile device.

Further, such application may enable members to build mutual trust.

### Second Embodiments

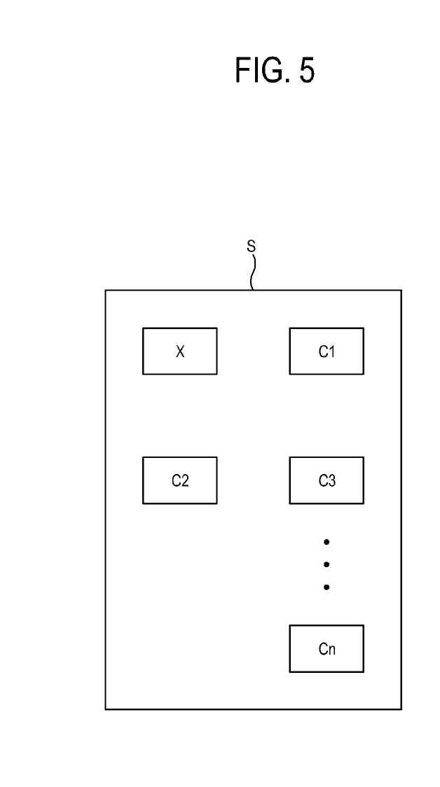

Hereinafter, an automatic creating method of a couple application according to the present invention will be described in detail with reference to FIGS. 5 to 8.

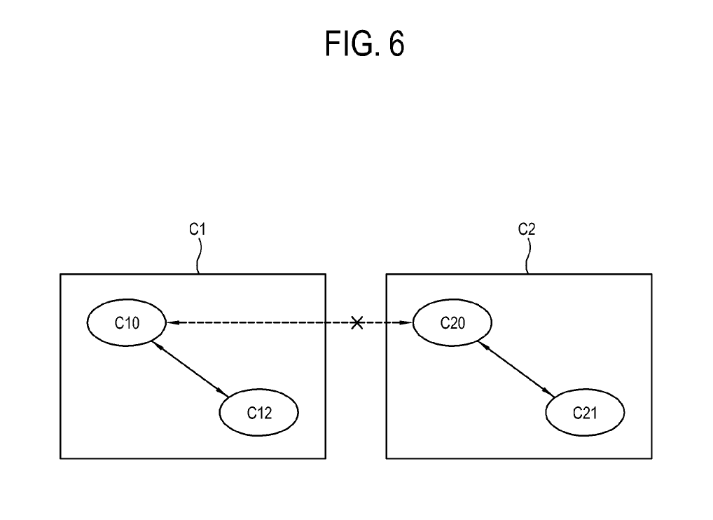

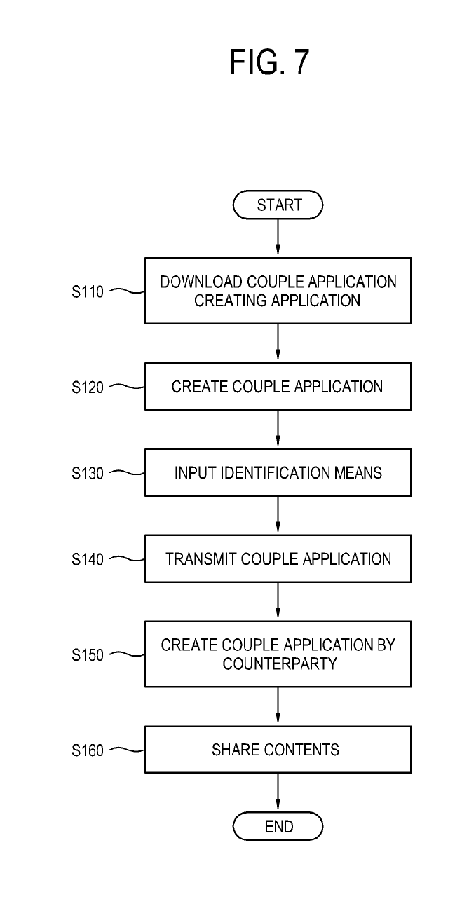

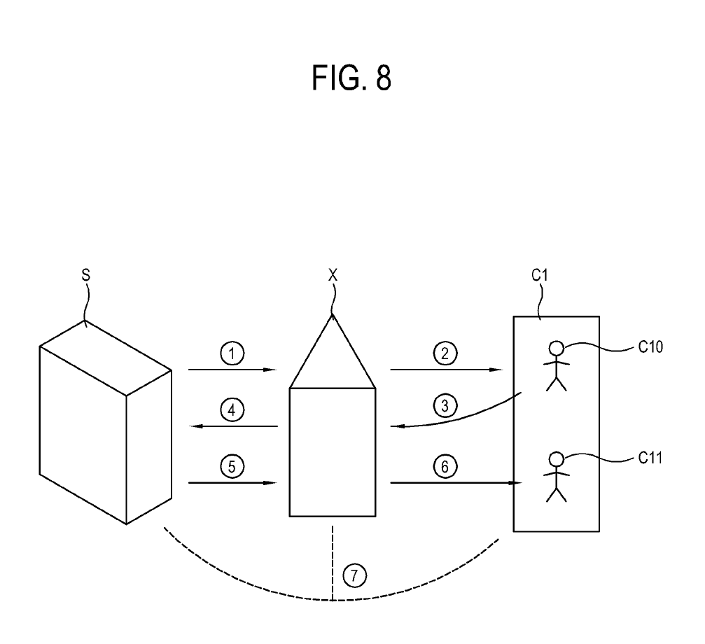

FIG. 5 illustrates a concept of an exemplary second embodiment of the present invention. FIG. 6 illustrates an example of a couple application which is created in FIG. 5. FIG. 7 is a block diagram according to the exemplary second embodiment of the present invention. FIG. 8 illustrates a creating method of the couple application according to the present invention.

As shown therein, an automatic creating method of a couple application according to the present invention includes a couple application creating application X and a plurality of couple applications C created by the couple application creating application X in a server S.

The couple application creating application X may be present in Android's or Apple's application store on the web, and an administrator C10 searches, downloads and installs the couple application creating application X in his/her electronic device including a mobile phone, etc. (S110).

The administrator C10 creates the couple application C in his/her electronic device (S120). The administrator C10 may easily create the couple application C without using an additional tool. For example, the administrator C10 may click ‘create new couple application’ from the couple application creating application X and create the couple application.

The administrator C10 designates a counterparty C11 with whom he/she shares contents, and inputs an identification means of the counterparty C11 in the created couple application C (S130). The identification means may include one of an ID number of the mobile device, and resident registration number, email address and mobile telephone number of the counterparty C11. The identification means may include at least two of the foregoing.

Then, the administrator C10 transmits the created couple application C to the designated counterparty C11 (S140). Such transmission may be conducted via email or the number of the mobile device including a smart phone.

The transmitted couple application C is automatically created if the counterparty C11 is consistent with the identification means input by the administrator C10 and permits such creation (S150).

Then, the administrator C10 and the counterparty C11 may become a couple and share the created couple application C (S160). That is, the created couple application C is an exclusive space for only the administrator C10 and the counterparty C11. In the couple application C, the administrator C10 and the counterparty C11 may freely use messages, photos, and video, which may be shared therebetween. The couple application C is an exclusive space for the administrator C10 and the counterparty C11, and others may not subscribe for the couple application C.

For example, even if one of members G20 and G21 of another couple application C2 or a third party designates either the administrator C10 or the counterparty C11 and transmits the another couple application C2, they are already members G10 and G11 of the couple application C1 and thus the couple application C2 is not permitted by a receiver of the administrator C10 or the counterparty C11.

However, if the administrator C10 or the counterparty C11 withdraws from the couple application C1 which is exclusive for the administrator C10 and the counterparty C11, the couple applications C1-1 and C1-2 become independent couple applications, and upon such withdrawal and thereafter, the couple application C1 may not be used for sharing contents therebetween.

The administrator C10 or the counterparty C11 may not transmit the created couple application C to a third party. That is, the administrator C10 may not create another or several couple applications C. The counterparty C11 may not become an administrator C10 who creates another couple application C.

Such couple application C may be an Internet communication space which is very useful for couples.

The couple applications C which are created by the couple application creating application X are automatically created and designated with ID numbers and names C1, C2, C3, . . . and Cn and may be registered with and managed by the server S. For example, management of the server S may include cloud computing, etc. That is, management of the server S may include a computing environment in which IT service such as data storage, network, content usage may be used at a time through the server S in the Internet.

Hereinafter, a creating method of the couple application according to the present invention will be described with reference to FIG. 8. For purposes of convenience, C1 will be explained as an example of the couple application.

A person who manages a program called the couple application creating application X stored and managed in the server S registers the program with the app store for mobile device users to download it (operation \textcircled{1}).

The administrator C10 who desires to create the initial couple application C1 downloads the couple application creating application X from the app store and creates the couple application C1 (operation \textcircled{2}).

The administrator C10 inputs the identification means and information of the counterparty C11 (operation \textcircled{3}). Such identification means and information is stored and managed in the server S through the app store (operation \textcircled{4}).

The server S allows the couple application C1 to be created in the app store (operation \textcircled{5}).

The administrator C10 transmits the couple application C1 to the counterparty C11, and if the identification means input by the administrator C10 is consistent with the mobile device of the counterparty C11, the couple application C1 is automatically created from the mobile device of the counterparty C11. During such process, the counterparty C11 may confirm the identification means and allow or and confirm the subscription for the couple application C1.

Then, the exclusive couple application C1 in which only the couple may communicate and share information is provided.

The overall process is managed by the server S, which may manage, store all information and materials and provide users with such contents and materials (operation \textcircled{7}).

The couple application C according to the present invention may increase mutual understanding between couples, increase trust and strength ties and improve happiness by expressing feelings through drawings, photos and texts.

According to the present invention, a user may create an exclusive Internet space for a couple without difficulty. Further, such space may store the couple's information and materials and provides the couple with the space in which they can talk to each other. Such application is exclusive for the couple as members and not allowed for others.

According to the present invention, an application in which a limited number of people may gather may be provided.

Also, an exclusive communication space used by only a limited number of people may be created simply and easily.

Further, such application is exclusive for members and not allowed for third parties in the Internet or in a mobile device.

Further, such application may enable members to build mutual trust.

Although a few exemplary embodiments have been shown and described, it will be appreciated by those skilled in the art that changes may be made in these exemplary embodiments without departing from the principles and spirit of the invention, the range of which is defined in the appended claims and their equivalents.

What is claimed is:

1. An automatic creating method of a group application, the method comprising:
(1) downloading and installing a group application creating application by an administrator;
(2) creating the group application from the application creating application by the administrator;
(3) inputting an identification means of a client relating to the group application by the administrator; and
(4) transmitting the group application to the client.

2. The method according to claim 1, further comprising:
(5) creating the group application automatically in a receiver of the client if the identification means at the operation (3) is consistent with the receiver of the client receiving the group application.

3. The method according to claim 1, wherein the identification means at operation (3) comprises one of an ID number of a mobile device, resident registration number, email address and mobile telephone number.

4. The method according to claim 3, wherein the group application which is created at operation (2) is registered with a server which manages the application creating application.

5. The method according to claim 4, further comprising:
sharing photos, video and documents registered by either the administrator or the client in the group application.

6. The method according to claim 5, wherein the client of the group application comprises study group members, club members and small gathering members comprising up to 50 members in total.

7. The method according to claim 5, further comprising:
maintaining a space exclusively for the administrator and the client of the group application and not disclosed to a third party.

8. An automatic creating method of a couple application, the method comprising:
(1) downloading and installing a couple application creating application by an administrator;
(2) creating a couple application from the couple application creating application by the administrator;
(3) inputting an identification means of a counterparty in the couple application by the administrator; and
(4) transmitting the couple application to the counterparty.

9. The method according to claim 8, further comprising:
(5) creating the couple application automatically in a receiver of the counterparty if the identification means at the operation (3) is consistent with the receiver of the counterparty receiving the couple application and the counterparty permits such creation.

10. The method according to claim 8, wherein the identification means at operation (3) comprises one of an ID number of a mobile device, resident registration number, email address and mobile telephone number.

11. The method according to claim 10, wherein the couple application which is created at operation (2) is registered with a server which manages the couple application creating application.

12. The method according to claim 11, further comprising:
sharing photos, video and documents registered by either the administrator or the counterparty in the couple application.

13. The method according to claim 12, wherein the couple application is not subscribed for by a third party except the administrator and the counterparty.
